(19) United States
(12) Patent Application Publication
(10) Pub. No.: US 2025/0118136 A1
(43) Pub. Date: Apr. 10, 2025

(54) GAMING MACHINE PLAYER INPUT METHODS AND APPARATUSES

(71) Applicant: Everi Games Inc., Austin, TX (US)

(72) Inventors: Cydny Audia, Reno, NV (US); Juan Mariscal, Las Vegas, NV (US); Logan DeBlieu, Austin, TX (US)

(21) Appl. No.: 18/906,143

(22) Filed: Oct. 3, 2024

Related U.S. Application Data
(60) Provisional application No. 63/543,055, filed on Oct. 7, 2023.

(51) Int. Cl. G07F 17/32

(52) U.S. Cl. CPC G07F 17/3211; G07F 17/3209

(57) ABSTRACT

A method includes causing a display device to display a number of game objects in an object field. Each game object is displayed in a player selectable state over a selection period for the respective game object and displayed as transforming to an unselected reveal state upon completion of the selection period for the respective game object to reveal an unselected result value. The method further includes receiving a number of player selection inputs, each player selection input selecting a respective one of the game objects residing in the object field while in the player selectable state. In response to the receipt of the player selection input for a respective game object, the method includes both debiting a player account by a predefined value and causing the display device to display the selected game object transform to a selection area reveal state displaying a result value.

### CROSS-REFERENCE TO RELATED APPLICATION

Applicant claims the benefit, under 35 U.S.C. § 119 (e), of U.S. Provisional Patent Application No. 63/543,055 filed Oct. 7, 2023, and entitled “Gaming Machine Player Input Methods and Apparatuses.” The entire content of this provisional application is incorporated herein by this reference.

### TECHNICAL FIELD OF THE INVENTION

The invention relates to user interface methods and apparatuses used in connection with a game available for play through a gaming machine. More particularly, the invention relates to player input methods and apparatuses for revealing game play results.

### SUMMARY OF THE INVENTION

It is an object of the invention to provide methods for revealing game results in response to a player input while also revealing prospective but uncollected game results. Another object of the invention is to provide a gaming machine configured to reveal both game results obtained by a player and prospective results that are not obtained by the player.

Methods according to a first aspect of the present invention include causing a gaming machine display device to display a number of game objects in an object field of the gaming machine display device. This step as with other steps in these methods is performed under control of a data processing system associated with a gaming machine including the display device. Methods according to the first aspect of the invention further include causing the gaming machine display device to display each game object in a player selectable state over a selection period (a period of time) for the respective game object and to display each game object transform to an unselected reveal state upon completion of the selection period for the respective game object. This unselected reveal state displays an unselected result value representing a value that the player could have potentially collected. Results are collected by a player in accordance with this first aspect of the invention in response to a player selection of a game object in the object field. In particular, methods according to this first aspect of the invention include receiving at least one player selection input, this player selection input and each other player selection input selects a respective one of the game objects residing in the object field while in the player selectable state for that respective game object. In response to the receipt of the player selection input for a respective game object while in the player selectable state for that respective game object, methods according to the first aspect of the invention further include both debiting a player account by a predefined value and causing the gaming machine display device to display the respective selected game object transform to a selection area reveal state displaying a selected result value. This selected result value indicates a prize to be awarded for the player selection of the respective game object.

A second aspect of the invention encompasses gaming machines that include a video display system, a player input system, a data processing system, and at least one memory device storing instructions executable by the data processing system to perform the method steps set forth above in connection with the first aspect of the invention.

Methods and gaming machines according to the first and second aspects of the invention allow a player to quickly reveal results of a game play by simply making player selection inputs selecting respective game objects while those objects reside in the object field in a respective selectable state. Additionally, these methods and gaming machines reveal to the player results that potentially could have been collected by the player had the player selected the respective game object at the appropriate time while the game object remained in the player selectable state. This reveal of potential results may be controlled to occur continuously in serial fashion both while a player is at the gaming machine and while no player is actively playing the game. Thus both players and potential players can observe potential winning results to enhance interest in the game. As will be described below in connection with example embodiments in accordance with the first and second aspects of the invention, the potential results revealed but not collected by a player may be actual results that would have been collected in response to an appropriate player input or simulated results.

Because a gaming machine in accordance with the second aspect of the invention may be implemented by a data processing executing program code, another aspect of the invention encompasses program products comprising one or more non-transitory computer readable data storage devices storing program code. Program code according to this third aspect of the invention includes game object graphic program code executable to cause a video display system of a gaming machine to display the number of game objects in the object field of the video display system. Each game object is displayed in the player selectable state over the selection period for the respective game object and each game object is displayed as transforming to the unselected reveal state upon completion of the selection period for the respective game object. Program code according to this third object of the invention further includes selection program code and result display program code. The selection program code is executable to receive player selection inputs from the player input system of the gaming machine, each player selection input selecting a respective one of the game objects residing in the object field while in the player selectable state for that respective game object. The result display program code is executable to, in response to the receipt of the player selection input for a respective game object while in the player selectable state for that respective game object, cause the video display system to display the respective selected game object transform to the selection area reveal state.

These and other aspects, advantages, and features of the invention will be apparent from the following description of representative embodiments, considered along with the accompanying drawings.

### BRIEF DESCRIPTION OF THE DRAWINGS

FIG. 1 is an isometric view of a gaming machine in accordance with an embodiment of the present invention.

FIG. 2 is a block diagram showing the various components that may be included in the gaming machine shown in FIG. 1.

FIG. 3 is a block diagram of a gaming system including gaming machines such as that shown in FIG. 1.

FIG. 4 is a flow chart of a process in accordance with an embodiment of the present invention.

FIG. 5 is a representation of a portion of a button panel in accordance with an implementation of the invention.

FIG. 6 is a representation of an object field and adjacent areas displayed on a display device in accordance with an implementation of the present invention.

FIG. 7 is a representation similar to FIG. 6 showing a game object being selected from the illustrated selection area.

FIG. 8 is a representation similar to FIG. 6 showing the selected game object in a selection area reveal state.

FIG. 9 is a representation similar to FIG. 6 showing an idle state for the gaming machine display.

FIG. 10 is a representation similar to FIG. 6 showing an unselected reveal state for one of the game objects.

FIG. 11 is a representation similar to FIG. 6 showing a bonus game object being selected from the illustrated selection area.

FIG. 12 is a representation similar to FIG. 11 showing the selected bonus game object after transforming to a bonus reveal state.

FIG. 13 is a representation similar to FIG. 12 showing game objects in the selection area each in the process of transforming to a respective bonus game reveal state.

FIG. 14 is block diagram showing software data structures and devices that may be employed in an implementation of a result generating processing system within the scope of the present invention.

### DESCRIPTION OF REPRESENTATIVE EMBODIMENTS

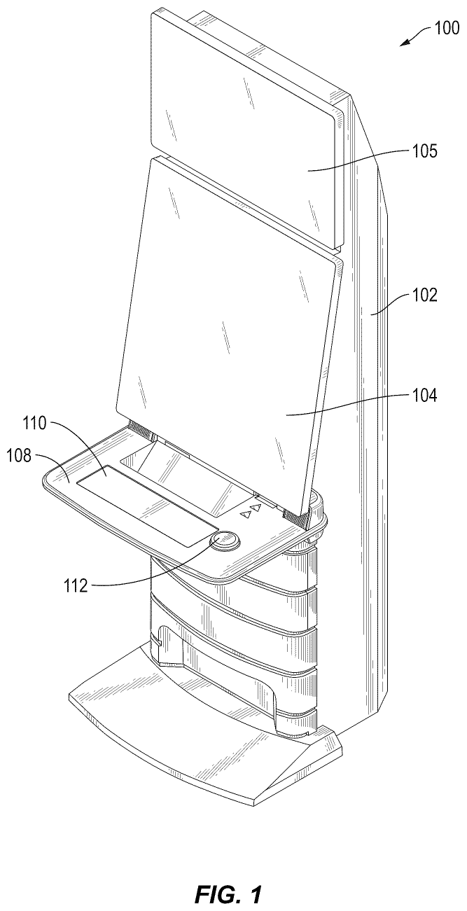

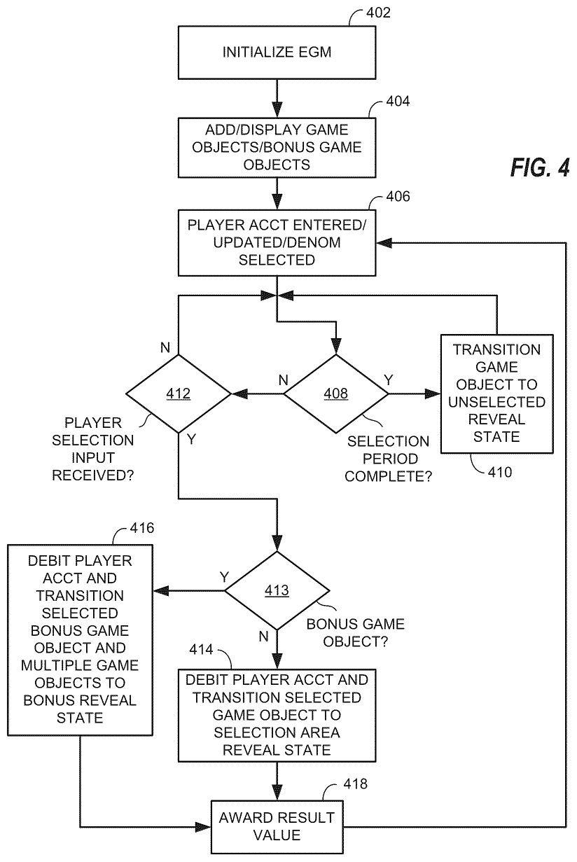

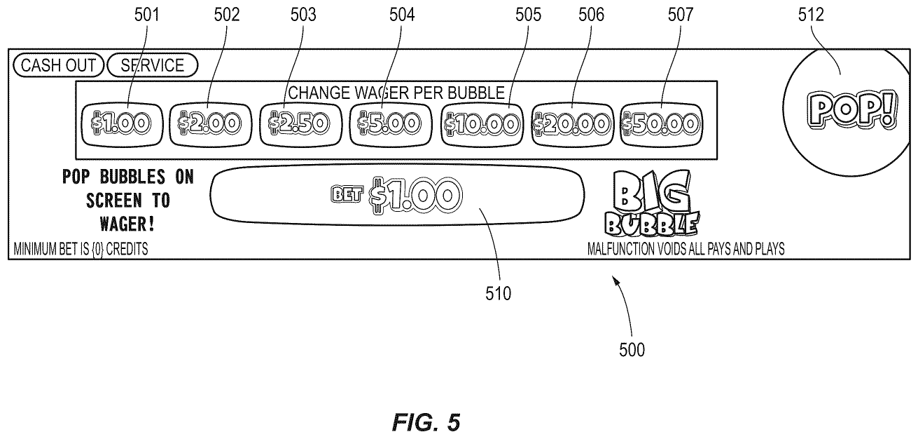

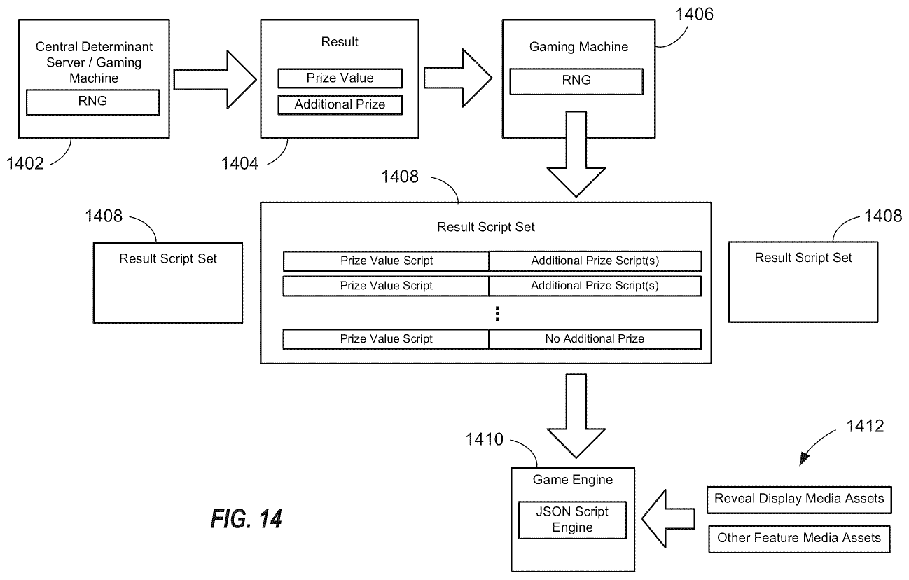

FIGS. 1-3 will be used to describe example gaming machines and gaming networks in which aspects of the present invention may be implemented. FIG. 4 will be used to describe example methods according to various implementations of the present invention. FIGS. 5-13 will be referenced below to describe example implementations of player selection and result revealing processes in accordance with an example implementation the present invention. FIG. 14 will be referenced below to describe certain software and data structures that may be employed in implementations of the invention.

Referring to FIG. 1, an example gaming machine 100 includes a cabinet 102 on which is mounted a video display system made up of main display device 104 and an upper display device 105. Example gaming machine 100 also includes a player control deck 108 extending forwardly below main display device 104. This example player control deck 108, which may also be referred to as a “button deck,” includes a player control touchscreen video display device 110 together with a mechanical “play” button 112. This button 112 and other virtual or mechanical “play” buttons may be referred to as gaming machine player input elements.

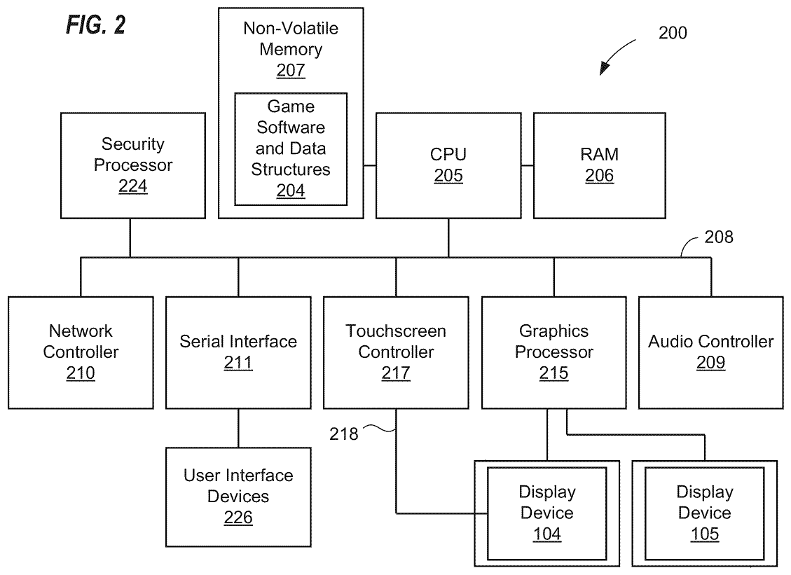

FIG. 2 shows a logical and hardware block diagram 200 of gaming machine 100 shown in FIG. 1. The block diagram 200 of FIG. 2 shows a data processing system that includes a processor (CPU) 205 along with a suitable connection to random access memory (RAM) 206 and a suitable connection to non-volatile memory 207. CPU 205 is connected on a system bus 208 with an audio controller device 209, a network controller 210, a serial interface 211, a graphics processor 215, and a touchscreen controller 217. Graphics processor 215, or another graphics processor included in the gaming machine but not shown in this diagram, may provide a suitable video output to one or more display devices such as display device 104 and upper display device 105. Display device 104 in this example comprises an LCD or OLED video display monitor, for example, having a forward facing display area. Display device 105 may also comprise an LCD or OLED display monitor having a forward facing display surface. Main display device 104 is shown in FIG. 2 as a touchscreen display device having a touchscreen element connected via signal path 218 to touchscreen controller 217. It will be appreciated that the touchscreen element itself may comprise a thin film element on or associated with the forward facing display area of display device 104 and is not shown separately in these views. Touchscreen controller 217 may also be connected via a suitable signal path (not shown) to receive signals from a touchscreen element (not shown) associated with video display device 110 mounted on the player control deck 122 in this example.

Those familiar with data processing devices and systems will appreciate that other basic electronic components will be included in gaming machine 100 such as a power supply, cooling systems for the various system components, audio amplifiers, audio speakers, and other devices that are common in gaming machines. These additional devices are omitted from the drawings so as not to obscure the present invention in unnecessary detail.

All of the elements 205, 206, 207, 208, 209, 210, and 211 shown in FIG. 2 are elements commonly associated with a personal computer, although they may be specially designed and configured so that gaming machine 100 has a hardware configuration approved by one or more regulatory authorities such as the Navada Gaming Commission for use in casino gaming (that is, in a wagering game environment). These elements may be mounted on one or more circuit boards housed within cabinet 102 with or without a separate enclosure. Those familiar with data processing systems and the various data processing elements shown in FIG. 2 will appreciate that many variations on this illustrated structure may be used within the scope of the present invention. For example, since serial communications are commonly employed to communicate with a touchscreen controller such as touchscreen controller 217, the touchscreen controller may not be connected on system bus 208, but instead include a serial communications line to serial interface 211 (which may be a USB controller for example). Also, each touchscreen may include a dedicated touchscreen controller. It will also be appreciated that some of the devices shown in FIG. 2 as being connected directly on system bus 208 may in fact communicate with the other system components through a suitable expansion bus. Where such a controller is included in a gaming machine in accordance with the present invention, audio controller 209, for example, may be connected to the system via a PCI or PCIe bus or bus configured according to some other expansion bus standard. System bus 208 is shown in FIG. 2 merely to indicate that the various components are connected in some fashion for communication with CPU 205 and is not intended to limit the invention to any particular bus architecture.

Numerous other variations in the gaming machine internal structure and system may be used without departing from the principles of the present invention. For example, a gaming machine in some embodiments of the present invention may rely on one or more data processors located remotely from the gaming machine itself. Embodiments of the present invention may include no processor such as CPU 205 or graphics processor such as 215 at the gaming machine and may instead rely on one or more remote data processing systems to perform the various control functions in accordance with the present invention. Thus unless specifically stated otherwise, the designation “gaming machine” is used in this disclosure and the accompanying claims to designate a system of devices that operate together to provide the indicated functions. A “gaming machine” may include a gaming machine such as gaming machine 100 shown in FIGS. 1 and 2, that is itself a system of various components, and may also include one or more components remote from a gaming machine cabinet (that is, remote from the cabinet 102 of gaming machine 100 in FIG. 1). As used herein, the designation “gaming machine” encompasses both a stand-alone gaming machine and a gaming machine along with one or more remote components for providing various functions (such as identifying prizes for a given play and controlling result display graphics and performing other operations).

It will also be appreciated that graphics processors are also commonly a part of modern computer systems. Although separate graphics processor 215 is shown for controlling display devices 104 and 105 (and perhaps display device 110 as well), CPU 205 or a graphics processor packaged with or included with CPU 205 may control all of the display devices directly without any separately packaged graphics processor. The invention is not limited to any particular arrangement of processing devices for controlling the display devices included with gaming machine 100. Also, a gaming machine implementing the present invention is not limited to any particular number of video display devices or any particular types of video display devices.

In the illustrated gaming machine 100, CPU 205 executes software, that is, program code represented at 204 in the figure, that ultimately controls the entire gaming machine including the receipt of player inputs and the presentation of the graphics or information displayed through the display devices 104, 105, and 110 and any other display devices associated with the gaming machine. This program code may include various data structures defining various assets (such as graphics assets for example) employed in the course of presenting the given game at gaming machine 100 and performing the process described below in connection with FIG. 4. CPU 205 also executes software related to communications handled through network controller 210, and software related to various peripheral devices such as those connected to the system through audio controller 209, serial interface 211, and touchscreen controller 217. CPU 205 may also execute software to perform accounting functions associated with game play. Random access memory 206 provides memory for use by CPU 205 in executing its various software programs while the nonvolatile memory or storage device 207 may comprise a mass storage device providing storage for game software (program code) prior to loading into random access memory 206 for execution, or for programs and program assets not in use, or for other data generated or used in the course of gaming machine operation. Network controller 210 provides an interface to other components of a gaming system in which gaming machine 100 may be included.

It should be noted that the invention is not limited to gaming machines employing the specially configured general purpose processing devices and personal computer-type arrangement of processing devices and interfaces shown in example gaming machine 100. Other gaming machines through which the invention may be implemented may include one or more special purpose processing devices to perform the various processing steps for implementing the invention.

FIG. 2 shows the gaming machine including user interface devices 226 (part of a player input system) connected to serial interface 211. These user interface devices may include various player input devices such as “play” button 112 in FIG. 1 and other mechanical buttons, virtual buttons shown on touchscreen button panel 110 in FIG. 1, and/or levers, and other devices. It will be appreciated that the interface between CPU 205 and other player input devices such as player card readers, voucher readers or printers, and other devices may be in the form of serial communications. Thus serial interface 211 may be used for those additional devices as well, or the gaming machine may include one or more additional serial interface controllers. However, the interface between peripheral devices in the gaming machine, such as player input devices, is not limited to any particular type or standard for purposes of the present invention.

FIG. 2 also shows that gaming machine 100 shown in FIG. 1 includes a security processor 224 which may include verified regulated read only memory or flash memory. Security processor 224 in this example comprises a special purpose microprocessor or processor core that functions to control the boot process of gaming machine 100 (FIG. 1) and verify that various firmware and software modules thereon match those approved by the appropriate regulators. This verification may be performed before the modules are loaded into RAM 206 in the example of FIG. 2. Security processor 224 may perform various cryptographic verification procedures to verify such firmware and software modules, including maintaining keys, accessing a key verification authority, and maintaining and checking digital signatures. Security processor 224 may be a separate processor connected on system bus 208 as depicted in FIG. 2 or may be embodied as a processing core within CPU 205 or a processor packaged with CPU 205.

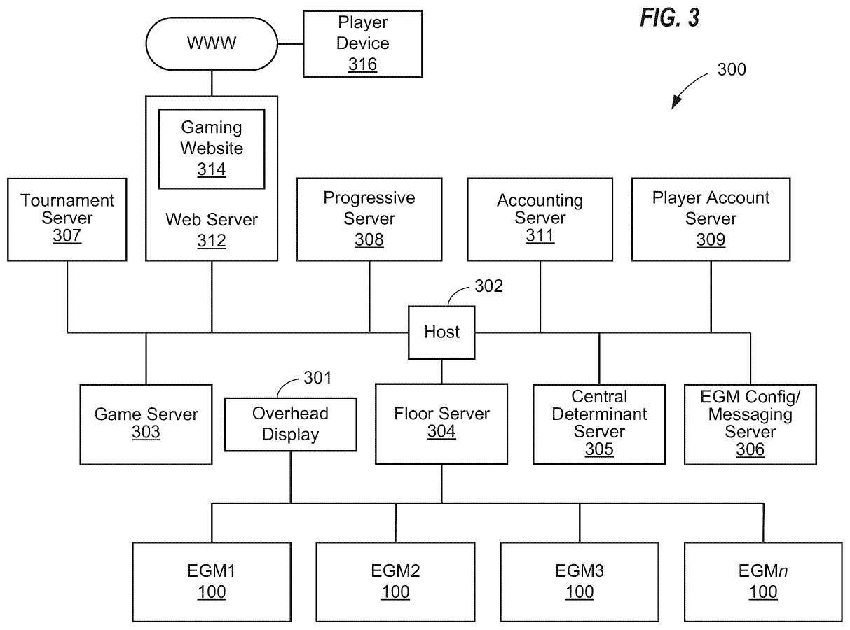

Referring now to FIG. 3, a networked gaming system 300 associated with one or more gaming facilities may include one or more networked gaming machines 100 (shown in FIG. 3 as EGM1-EGMn) connected in the network by suitable network cable or wirelessly. Networked gaming machines 100 and one or more overhead display devices 301 may be operatively connected so that the overhead display device or display devices may mirror or replay the content of one or more displays of gaming machines 100. For example, the display content for a given gaming machine 100 may be transmitted through network controller 210 to a controller associated with the overhead display device(s) 301. In the event gaming machines 100 have cameras installed, the respective player's video images may be displayed on overhead display device 301 along with the content of the player's gaming machine display.

The example gaming network 300 shown in FIG. 3 includes a host server 302 and floor server 304, that together may function as an intermediary between floor devices such as gaming machines 100 and back-office devices such as the various servers described below. Game server 303 may provide server-based games and/or game services to network connected gaming devices such as gaming machines 100. Central determinant server 305 may be included in the network to identify or select lottery, bingo, or other centrally determined game results and provide the result information to networked gaming machines 100 that present the games or game results to players.

EGM configuration and messaging server 306 may provide game and non-game content and operational software for use by the gaming machines 100 in the course of providing games and while the gaming machines are unused and in an idle state. For example, server 306 may control the distribution of game software and graphic control assets to the gaming machines as well as advertising messages and other messages that may be presented using a display device of a gaming machine 100.

Tournament server 307 may be included in the system for controlling or coordinating tournament functions. These functions may include maintaining tournament player scores and ranking during the course of tournament play and communicating this information to the various gaming machines 100 participating in the tournament. Tournament server 307 may also function to enroll players in tournaments, schedule tournaments, and maintain the time remaining in the various tournaments.

Progressive server 308 may maintain progressive pools for progressive games that may be available through the various gaming machines 100. In some implementations, progressive server 308 may simply receive communications indicating contribution amounts that have been determined by processes executing at the various gaming machines 100 or elsewhere in the gaming network. Alternatively, progressive server 308 may perform processes to determine the contribution amounts for incrementing the various progressive pools that may be maintained. Progressive server 308 may also periodically communicate current pool values back to the various gaming machines 100 and may participate in communicating awarded progressive prize amounts to the gaming machines and in adjusting the progressive prize pools accordingly. In some implementations, progressive server 308 may also determine or participate in determining when a progressive prize triggering event occurs.

Accounting server 311 may receive gaming data from each of the networked gaming devices, perform audit functions, and provide data for analytical programs. Player account server 309 may maintain player account records, and store persistent player data such as accumulated player points and/or player preferences (for example, game personalizing selections or options).

Example gaming network 300 also includes a gaming website 314 that may be hosted through web server 312 and may be accessible by players via the Internet. One or more games may be displayed and played by a player through a player device 316 such as a wired or wireless personal computer or handheld wireless device (for example, an Android® operating system smart phone, Apple® iPhone® smart phone, personal digital assistant (PDA), iPad® or other tablet computer, etc.). To enter website 314, a player may log in with a user name that may, for example, be associated with the player's account information stored on player account server 309. Once logged in to website 314 the player may play various games on the website. Also, website 314 may allow the player to make various personalizing selections and save the information so it is available for use during the player's next gaming session. Such a gaming session may be either online through a device such as player device 316 or at a casino establishment having the gaming machines 100.

Gaming network 300 illustrated in FIG. 3 is provided merely as an example of a gaming network that may include gaming machines with display assemblies according to aspects of the present invention and is not intended to be limiting in any way.

The flowchart of FIG. 4 shows an example process performed in accordance with an implementation of the present invention by a gaming machine such as gaming machine 100 in FIG. 1. The illustrated process begins with initializing the gaming machine (EGM) as shown at process block 402. This initialization comprises the boot up process for placing the gaming machine in condition to operate in accordance with the applicable environment, such as a regulated casino environment for example. The initialization process may include security processing conducted by a security processor such as processor 224 in FIG. 2 to ensure the gaming machine is specially configured for the gaming environment.

Once the gaming machine is initialized and the game program code is executing on the gaming machine, the illustrated example process includes adding and displaying game objects and/or bonus game objects as shown at process block 404. This includes causing the display device such as main display device 104 in FIG. 1 to display an object field and then causing the game objects to be displayed over their respective selection period of time. It will be noticed in FIG. 4 that this display of game objects occurs in the process even before a player has placed funds on the gaming machine or otherwise placed the gaming machine in condition to accept wagers as shown at process block 406. Thus the process of displaying game objects in the object field and transforming states as will be described further below may occur continuously whether a player is making wagers at the particular gaming machine or not.

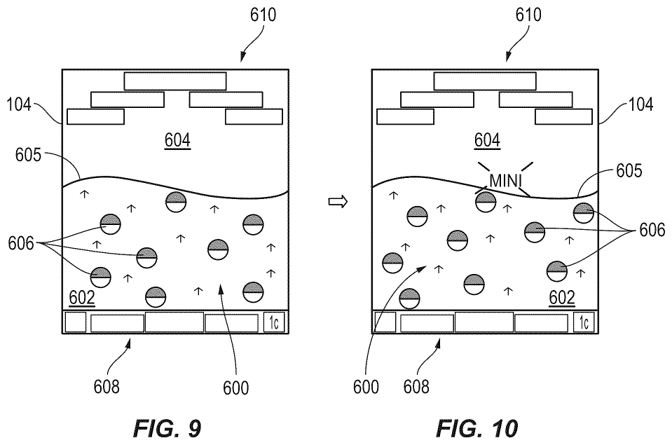

The process shown in FIG. 4 includes determining whether a selection period for any of the displayed game objects has expired as indicated by decision box 408. This determination may be made as a function of time that the game object has been displayed or as a function of location as will be described further below in the example shown in FIGS. 5-13. Regardless of how the determination is made, if the selection period has expired for a given game object, the process proceeds to transform that object to the unselected reveal state as shown at process block 410. An example of this transformation will be described below in connection particularly with FIGS. 9 and 10. If the selection period is not complete as indicated by the negative outcome from process block 408, a determination is made as to whether a player selection input has been received for a given game object or bonus game object this determination is indicated at decision block 412 in FIG. 4. If no player selection input has been received, the process loops back to the determination at decision box 408. If a player selection has been received for a given game object as indicated by an affirmative outcome at process block 412, the process proceeds to a determination whether the player selection input was received for a game object associated with a bonus presentation as indicated at decision box 413. It should be noted here that implementations of the invention may include no game objects associated with a bonus presentation (that is, bonus game objects) but only game objects that all respond as described below in connection with process block 414. Of course, in these cases the determination of process block 413 is omitted and the process instead proceeds to the actions taken as indicated at process block 414. As will be illustrated in the examples described below, all game objects may have the same appearance and may not be distinguishable as game objects not associated with a bonus presentation and game objects (bonus game objects) that are associated with a bonus presentation.

In the example of FIG. 4, if the player selection is for a game object that is not associated with a bonus presentation (that is, the selected game object is not a bonus game object) the process proceeds to debit the player account and transform the selected game object to the selection area reveal state as indicated at process block 414. It is noted here that the player selection input for a game object is the action that results in the debit to the player account. This is in contrast to games such as reel-type slot machines in which the player's account is debited in response to activating a play button or lever to initiate a reel spin which ultimately shows the result for the play.

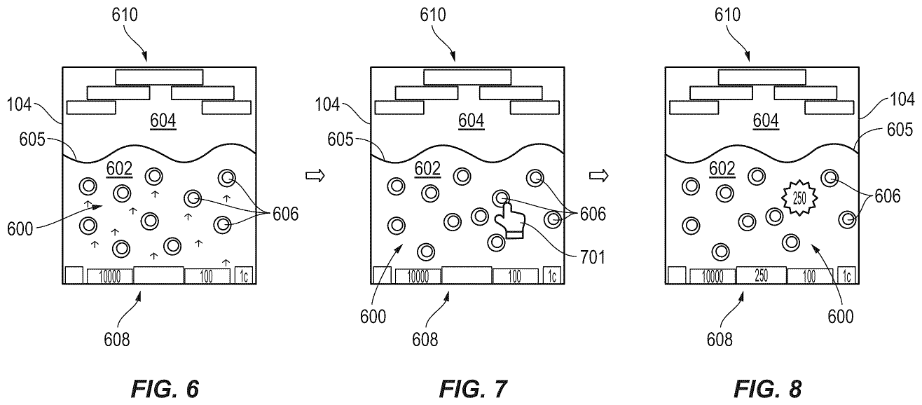

The invention encompasses a wide variety of graphical effects to transform a game object to the selection area reveal state. An example transformation will be described particularly with reference to FIGS. 6-8 below. In any event, the transformation to the selection area reveal state reveals a result associated with the selected game object which may be a zero value or a nonzero value for example. The process includes awarding any nonzero value for the play as shown at process block 418. This step may include crediting the player's account with the nonzero value.

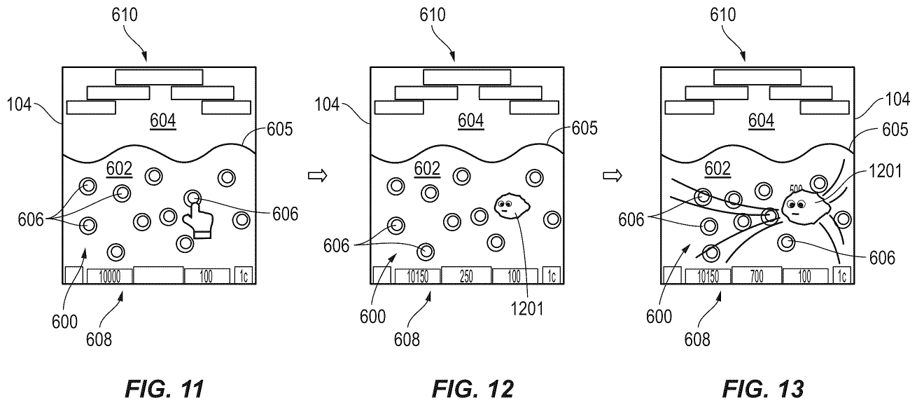

In the event the determination at process block 413 is that the selected game object is associated with a bonus presentation, the process then continues to the steps indicated at process block 416. A particular arrangement for the transformation of the selected game object (bonus game object) and multiple game objects as indicated at process block 416 will be described below in the example of FIGS. 11-13. Generally stated, however, the process includes debiting the player account for the selection of the respective game object (bonus game object) and the graphical transformation of both the selected game object (bonus game object) and other game objects in the object field of the gaming machine display. Of course, since each game object that transforms may be associated with a nonzero result value, the transformations indicated process block 416 may provide a mechanism for awarding large-value results. Regardless of the amount of result, the total of the result values revealed as shown at process block 416 is awarded at process block 418 similarly to an award after the process shown at process block 414.

After any award at process block 418, the process loops back to process block 406 where the player may increase the account or change the denomination for the next player selection input. Of course, the player may preferably activate a suitable control at the gaming machine to cash out at any time. Although not shown in FIG. 4, upon any such cashout input, the gaming machine may perform a suitable process to allow the player to collect the account value then remaining on the gaming machine and may loop back to the idle state indicated at process block 404 where game objects are continuously shown being added to the object field and then ultimately transforming to the game object unselected reveal state as indicate at process block 410.

It should be noted that although FIG. 4 suggests that the determinations of whether a selection period is complete and whether a player selection input has been received are performed serially, these processes may be performed in any order or in parallel. Regardless of how these determinations are made and their relative order, the process causes any game object to transform to the unselected reveal state indicated at process block 410 upon completion of the selection period for that game object and causes any game object selected by a player to go through the reveal processes described in connection with process box 414 or 416.

FIG. 5 shows a portion of a button panel 500 that may be used in some implementations of the present invention. This example button panel may comprise a virtual button panel displayed on touchscreen panel 110 shown in the example gaming machine 100 of FIG. 1. Example button panel 500 includes seven wager level selection buttons 501 through 507 each associated with a respective wager value for a player selection of a game object in accordance with the present invention. In this example, each wager selection button is associated with a different denomination for the wager. For example the one dollar wager associated with wager selection button 501 is associated with a one cent denomination. Wager selection buttons 502, 503, 504, 505, 506, and 507 are associated with the denomination two cents, five cents, 10 cents, one dollar, two dollars, and five dollars for example. Button panel 500 also includes a current wager indicator 510 which shows the wager level in effect at the gaming machine at the present time. In this case the wager level is the wager level associated with wager selection button 501, a one dollar wager for each player selection in accordance with the invention. A player may change the denomination/wager level simply by selecting a different one of the wager level buttons 502 through 507 and upon such selection the wager level of that selected button will appear on current wager indicator 510 in lieu of the wager level shown in FIG. 5. Button panel 500 further includes a player selection input button 512. This virtual button 512 may be activated (via a touch by the player) to select one of the game objects in accordance with the invention as will be described in the examples below. It should be noted that the physical button 112 shown in FIG. 1 may comprise a player selection input button that may be activated (pressed by a player) to provide the same function as virtual button 512. Of course the present invention is not limited to a virtual button panel as shown in FIG. 5. All or part of this same arrangement of buttons and indicators can be implemented as mechanical buttons. Also the invention is not limited to this example number of wager levels and denominations. More or fewer wager levels may be used in various implementations. Numerous alternative button panels and button layouts are possible within the scope of the present invention. For example, some implementations may dispense with the current bet indicator 510 and show the current bet level by highlighting a selected one of the wager selection buttons 501 through 507 while graying out or otherwise deemphasizing the remaining wager selection buttons. Also, it is possible to rely on the physical button such as button 112 as the player selection input button rather than provide a virtual player selection button such as button 512. Some implementations may include no player selection button and rely on a touchscreen associated with object field to receive player inputs as described below.

FIGS. 6-8 may be used to describe an example implementation following the process described in FIG. 4. FIGS. 6-8 each show a schematic representation of display device in FIG. 1. This simplified representation shows an object field 600 generally in the area between lower boxes 608 and upper boxes 610. Object field 600 is divided into a selection area 602 and an auto-reveal area 604 with a graphic element 605 representing a boundary between the two areas. A number of game objects 606 are shown in selection area 602. In this example display, selection area 602 represents an area of water while auto-reveal area 604 represents an area above the water level indicated by boundary 605. Each of the game objects 606 in this example is a representation of a bubble with each bubble moving upwardly as indicated by the arrows in selection area 602 toward auto-reveal area 604. In the example of FIGS. 6-8, lower display boxes 608 include a number of individual boxes or display areas for displaying information relevant to play at the gaming machine. For example, one of the boxes included at may display an indication of the current denomination while another one of the boxes May display a value for the current or most recent result revealed in accordance with the present invention. Other of the boxes included at 608 may display the player's account value at the gaming machine and the current bet level in effect for player selections in accordance with the invention. The upper boxes 610 in this example may display various jackpot prizes available in the game. For example, some of the boxes in the set shown at 610 may include a non-progressive jackpot prize level available as a result for a selection of a given one of the objects 606. Other of the boxes included at 610 may show progressive prizes that may be available for the selection of a game object 606. Alternatively, all of the boxes at 610 may show non-progressive prizes or all of the boxes at 610 may show progressive prizes, or some other variable prize.

FIG. 7 shows a state of the example display shown in FIG. 6 with one of the game objects 606 being selected by a player as indicated by the hand graphic 701. It will be appreciated that in an actual implementation the hand graphic 701 may not appear on the display upon selection of one of the objects 606. Hand graphic 701 is used in the example merely as a way to indicate that a particular one of the game objects is being selected by the player. This selection may be performed by the player touching the indicated game object 606 as the game object rises through selection area 602. As an alternative to touching one of the objects 606 on a touchscreen showing object field 600, a player may select one of the game objects 606 by activating a control outside of the object field such as player selection input button 512 shown in FIG. 5 or the mechanical play button 112 shown in FIG. 1. Any suitable procedure may be followed for which specific one of the game objects 606 is selected in response to activating a player selection input button such as 512 in FIG. 5 or 112 in FIG. 1. In some implementations when a player activates the player selection input button 512, the presently uppermost game object 606 in selection area 602 may be selected, that is, the game object 606 nearest to auto-reveal area 604 at the time the player selection input button is activated. Alternatively, one of the game objects 606 may be selected at random in response to activation of the player selection input button such as 512. As a further alternative, activation of player selection input button 512 in FIG. 5 may cause the lowermost object 606 to be selected.

Regardless of specifically how a game object 606 is selected, in response to the selection the player account may be debited by the wager level then in effect at the gaming machine and the selected game object may be shown as transforming to a selection area reveal state displaying a selected result value for the wager placed by making the selection. In the example of FIG. 8, the selected game object (the game object indicated by hand graphic 701 in FIG. 7) has transformed to a selection area reveal state displaying the result in the form of a numerical value “250.” This value “250” represents the selected result value obtained for the player's wager made by selecting the indicated object 606 in selection area 602. The value “250” may be a credit value or a cash value for example.

FIGS. 9 and 10 may be used to describe the behavior in accordance with the invention while the gaming machine is idle. Such an idle state may occur when there is no player that has enabled the gaming machine to accept a wager or while a player has enabled the gaming machine for accepting wagers but has not selected one of the game objects. As indicated in FIG. 9, game objects 606 continue to rise through selection area 602, each following a respective path in a direction toward auto-reveal area 604. When one of the game objects 606 reaches auto-reveal area 604, that game object transforms to an unselected reveal state. In this example display where 605 shows a boundary between selection area 602 and auto-reveal area 604, a given game object 606 rising to either contact boundary 605 or partially or fully traversing boundary 605 may be taken as a point where the game object reaches auto-reveal area 604. Regardless of what is defined as reaching auto-reveal area, this unselected reveal state reveals an unselected result value. In the example of FIG. 10 the unselected result value is shown as shown as “MINI” jackpot value which may represent one of the jackpot prizes available in the game and shown in one of the upper boxes 610. Thus, the transformation to the unselected reveal state displays a result that at least appears to be a result a player could have obtained had the player selected that respective game object while it remained in selection area 602.

FIGS. 11 to 13 may be used to describe the case where the game object 606 selected by the player by their selection input is associated with a bonus presentation, that is, the selected game object comprises a bonus game object. In this example, bonus game objects are indistinguishable from game objects 606 as they traverse selection area 602. The hand symbol is used again in FIG. 11 simply as a convenient way to indicate a selection of a particular bonus game object 606. In response to the selection, the player account is debited by the wager level then in effect for selections in accordance with the invention and the selected bonus game object transforms to a bonus reveal state 1201. As part of the bonus reveal state, some or all of the other game objects 606 then residing in the selection area 602 each transformation to a respective reveal state for that game object to displaying a result value associated with the respective game object. The example result graphic shown in FIGS. 12 and 13 shows the selected bonus game object 606 indicated by hand graphic 701 transforming to a graphic image of a puffer fish 1201 which acts to cause a number of the other game objects 606 then in player selection area 602 to move toward the puffer fish and ultimately pop (in this example) to reveal a result value for each such game object 606. FIG. 13 shows the state of the display where the game objects 606 are being drawn toward puffer fish graphic 1201 but before the transformation to their respective bonus reveal state to reveal the respective result. In any event, the overall result for the player's selection of the bonus game object is the sum of the result values revealed by the various individual game objects as bonus result values. In some variations of this basic mechanic, a multiplier may be associated with the selection of a bonus game object. For example the puffer fish graphic 1201 in the example of FIGS. 12 and 13 may show a multiplier value or a multiplier value increasing over time to a final multiplier value which is applied to all of the values revealed by the game objects 606 that have transformed to the reveal state as the result of the player's selection of the bonus game object.

Numerous variations are possible within the scope of the invention as alternatives to the example graphic shown in FIGS. 6-13. For example, although the game objects 606 are shown as bubbles rising through a selection area 602 represented by water, the selection area and the reveal area may be arranged differently as may the movement of the game objects through the selection area. For example, an implementation may show a graphic of a central area in a display device representing the auto-reveal area graphically as a black hole or portal with the player selection area comprising an area surrounding that central graphic. The movement of the game objects and bonus game objects in this example may comprise a movement toward the central location with the various game objects and bonus game objects approaching the auto-reveal area central location from different angles on the display. Also, although implementations of the invention are well suited for displaying result values in terms of credit or cash numerical values, the result value may indicate a non-cash or non-credit prize such as merchandise for example.

FIG. 14 comprises a block diagram of software and data structures that may be employed in embodiments of the present invention. The block diagram of FIG. 14 shows an arrangement 1402 for generating a first random number, an arrangement 1404 for obtaining a result based on that first random number, and an arrangement 1406 for generating a second random number. The result from 1404 is used to select a result script set 1408 corresponding to that result and the second random number from 1406 is used to select a result script from the selected script set. Game engine 1410 is operable to execute the selected result script to control the gaming machine display system to display the randomly selected result for the given player selection input using media assets 1412 from an arrangement for storing such assets.

For centralized gaming architectures, a device such as a central determinant server (305 in FIG. 3 for example) may comprise the random number generating arrangement 1402. In such a centralized gaming architecture, the gaming machine may request a random number when a result is needed as will be described further below, and the central determinant server May include a random number generator that communicates the first random number to the gaming machine in response to the request. In many Class III type gaming systems, the random number generating arrangement 1402 comprises a random number generator at the gaming machine itself. In either case the random number generator may be a hardware-based random number generator or other random number generator conforming to applicable regulations for both security and randomness.

The arrangement 1404 for selecting a result based on the random number from block 1402 may likewise reside at a centralized device such as a central determinant server in a centralized gaming architecture or at the gaming machine itself. In either case, the arrangement 1404 may select a result by using the first random number from 1402 to select from a pool of available results to produce a desired prize distribution and payout percentage. Thus the application of arrangements 1402 and 1404 represent a result generation or identification process.

The second random number generating arrangement 1406 in FIG. 14 comprises any suitable arrangement for generating a second random number. Where the gaming machine includes the arrangement 1402 for generating the first random number, the arrangement 1406, May comprise the same random number generator used to generate the first random number. Regardless of which specific element in the system is used to generate the second random number, that second random number is used in this example implementation of FIG. 14 together with the result selected at 1404 to select a specific result script to display the result at the gaming machine. Specifically, the gaming machine uses the result from 1404 to select a result script set 1408 that includes result scripts to show that particular result, that is, the prize associated with that result. The gaming machine also uses the second random number from block 1406 to select a specific one of the result scripts in the selected result script set 1408. For example, if the overall result to be revealed correlates to a result of 1000 credits, the set 1408 containing scripts showing a 1000-credit overall result for the given selection input is selected and the second random number is used to select one of these scripts. The given script selected from a set 1408, May show only the result revealed by a single selected game object (606 in FIGS. 6-8) in accordance with the invention or revealed as a bonus presentation as described above in connection with FIGS. 11-13.

The specific script selected from the set 1408 for the result to be awarded is then loaded to the game engine 1410 and executed to cause the display system to display the desired graphics. The game engine 1410 may, for example, include a JSON script engine. Regardless of the nature of game engine 1410, it may access media assets 1412 stored in the game software and use these media assets to cause the gaming machine display system to display the game result. The media assets 1412 may include data structures for driving/controlling the various graphic elements shown in displays according to the present invention.

In other implementations of a prize revealing arrangement according to the present invention, the result script sets may not be stored as indicated at 1408 in FIG. 14 and selected with a second random number by the arrangement shown at 1406. In these implementations, control signals to cause the gaming machine display system to generate the displays for revealing the prize value in accordance with the present invention may be generated in response to the random result selected at the arrangement 1404 in FIG. 14. In particular, the result selected at 1404 may include a prize value to be displayed/revealed in accordance with the present invention and the display control commands for controlling the display device(s) to reveal that prize value may be built/generated according to a suitable process.

Regardless of whether control scripts are generated ahead of time and stored as 4 shown in FIG. 14, or whether they are generated “on-the-fly” in response to the result selected at in FIG. 14, the control for the display devices may be accomplished by the same process.

In implementations of the invention where the result for each player selection is obtained via a lottery ticket or record set, first random number generator 1402 shown in FIG. 14 may be replaced by the lottery record selection system. The result dictated by the lottery record may then be used to select the corresponding result script set 1408 in FIG. 4, and a script may be randomly selected from that script set. A bingo gaming system could also be used in place of the first random number device 1402. Also, in either the lottery-type system or bingo system, the result for the player selection may also dictate a specific script without the need for a random number as generated at 1406 in FIG. 14.

Regardless of how the result is selected for a given player selection in accordance with the invention, implementations in accordance with the invention may associate a given one of the game objects with a given result either when the game object first appears in selection area (area 602 of the examples of FIGS. 6-13) or at the time a given game object is selected by the player. Particularly in class II gaming where the result is obtained from a bingo game, the result may be associated with the game objects at the time of selection. In these cases, where a game object transforms to its unselected reveal state, an unselected result value may be associated with that object at the time of the transformation. The assigned result preferably is assigned in accordance with the probabilities established for actual results in the game even though the results are generated only for purposes of the reveal to an unselected reveal state in accordance with the present invention.

As used herein, whether in the above description or the following claims, the terms “comprising,” “including,” “carrying,” “having,” “containing,” “involving,” and the like are to be understood to be open-ended, that is, to mean including but not limited to. Also, it should be understood that the terms “about,” “substantially,” and like terms used herein when referring to a dimension or characteristic of a component indicate that the described dimension/characteristic is not a strict boundary or parameter and does not exclude variations therefrom that are functionally similar. At a minimum, such references that include a numerical parameter would include variations that, using mathematical and industrial principles accepted in the art (e.g., rounding, measurement or other systematic errors, manufacturing tolerances, etc.), would not vary the least significant digit.

Any use of ordinal terms such as “first,” “second,” “third,” etc., in the following claims to modify a claim element does not by itself connote any priority, precedence, or order of one claim element over another, or the temporal order in which acts of a method are performed. Rather, unless specifically stated otherwise, such ordinal terms are used merely as labels to distinguish one claim element having a certain name from another element having a same name (but for use of the ordinal term).

In the above descriptions and the following claims, terms such as “top,” “bottom,” “upper,” “lower,” and the like are used with reference to the orientation of the figures unless specifically stated otherwise.

The term “each” may be used in the following claims for convenience in describing characteristics or features of multiple elements, and any such use of the term “each” is in the inclusive sense unless specifically stated otherwise. For example, if a claim defines two or more elements as “each” having a characteristic or feature, the use of the term “each” is not intended to exclude from the claim scope a situation having a third one of the elements which does not have the defined characteristic or feature.

The above described preferred embodiments are intended to illustrate the principles of the invention, but not to limit the scope of the invention. Various other embodiments and modifications to these preferred embodiments may be made by those skilled in the art without departing from the scope of the present invention. For example, in some instances, one or more features disclosed in connection with one embodiment can be used alone or in combination with one or more features of one or more other embodiments. More generally, the various features described herein may be used in any working combination.

1. A method including:
(a) under control of a data processing system, causing a gaming machine display device to display a number of game objects in an object field of the gaming machine display device;
(b) under control of the data processing system, causing the gaming machine display device to display each game object in a player selectable state over a selection period for the respective game object and to display each game object transform to an unselected reveal state upon completion of the selection period for the respective game object, the unselected reveal state displaying an unselected result value;
(c) under control of the data processing system, receiving at least one player selection input, each player selection input selecting a respective one of the game objects residing in the object field while in the player selectable state for that respective game object; and
(d) under control of the data processing system, in response to the receipt of the player selection input to select a respective game object while in the player selectable state for that respective game object, (i) debiting a player account by a predefined value and (ii) causing the gaming machine display device to display the respective selected game object transform to a selection area reveal state displaying a selected result value, the selected result value indicating a prize to be awarded for the player selection input for the respective selected game object.

2. The method of claim 1 wherein:
(a) the object field includes a selection area and an auto-reveal area with a graphic element representing a boundary between the selection area and the auto-reveal area;
(b) each game object is displayed as following a respective path of movement from the selection area toward the auto-reveal area; and
(c) the selection period for each respective game object terminates when that respective game object resides at least partially in the auto-reveal area.

3. The method of claim 2 wherein the player selection input for a respective one of the game objects is received in response to a player touch of that respective game object.

4. The method of claim 3 where in the player selection input for a respective one of the game objects is received in response to a player activation of a gaming machine player input element located outside of the object field.

5. The method of claim 4 wherein the respective game object selected in response to the player activation of the gaming machine player input element located outside of the object field comprises the respective game object located in the selection area nearest to the auto-reveal area as compared to each other game object in the selection area at the time of the player activation of the gaming machine player input element located outside of the object field.

6. The method of claim 5 wherein the gaming machine player input element located outside of the object field comprises a control located on a gaming machine button deck, the gaming machine button deck projecting forwardly from a gaming machine cabinet at a location below the object field.

7. The method claim 1 wherein the selected result value is associated with the respective game object at the time the respective game object is first displayed in the object field.

8. The method of claim 1 wherein the selected result value is associated with the respective game object in response to the player selection input selecting that respective game object.

9. The method of claim 1 further including:
(a) under control of a data processing system, causing the gaming machine display device to display a bonus game object in the object field of the gaming machine display device;
(b) under control of the data processing system, causing the gaming machine display device to display the bonus game object in a player selectable state for the bonus game object over a selection period for the bonus game object;
(c) under control of the data processing system, receiving a player selection input selecting the bonus game object residing in the object field while in the player selectable state for the bonus game object; and
(d) under control of the data processing system, in response to the receipt of the player selection input selecting the bonus game object, (i) debiting the player account by the predefined value, and (ii) causing the gaming machine display device to display the bonus game object transform to a bonus reveal state for the bonus game object and to display each of a number of the game objects then residing in the object field transforming to a respective bonus reveal state for that respective game object to display a respective bonus result value, each bonus result value indicating a prize to be awarded for the player selection input selecting the bonus game object.

10. A gaming machine including:
(a) a video display system;
(b) a player input system;
(c) a data processing system; and
(d) at least one memory device storing instructions executable by the data processing system to:
(i) cause video display system to display a number of game objects in an object field of the video display system;
(ii) cause the video display system to display each game object in a player selectable state over a selection period for the respective game object and to display each game object transform to an unselected reveal state upon completion of the selection period for the respective game object, the unselected reveal state displaying an unselected result value;
(iii) receive a number of player selection inputs, each player selection input selecting a respective one of the game objects residing in the object field while in the player selectable state for that respective game object; and
(iv) in response to the receipt of the player selection input to select a respective game object while in the player selectable state for that respective game object, cause the video display system to display the respective selected game object transform to a selection 6 area reveal state displaying a selected result value.

11. The gaming machine of claim 10 wherein:
(a) the object field includes a selection area and an auto-reveal area with a graphic element representing a boundary between the selection area and the auto-reveal area;
(b) each game object is displayed as following a respective path of movement from the selection area toward the auto-reveal area; and
(c) the selection period for each respective game object terminates when that respective game object resides at least partially in the auto-reveal area.

12. The gaming machine of claim 11 wherein the player selection input to select a respective one of the game objects is received in response to a player touch of that respective game object.

13. The gaming machine of claim 12 where in the player selection input to select a respective one of the game objects is received in response to a player activation of a gaming machine player input element located outside of the object field.

14. The gaming machine of claim 13 wherein the respective game object selected in response to the player activation of the gaming machine player input element located outside of the object field comprises the respective game object located in the selection area nearest to the auto-reveal area as compared to each other game object in the selection area at the time of the player activation of the gaming machine player input element located outside of the object field.

15. The gaming machine of claim 14 wherein the gaming machine player input element located outside of the object field comprises a control located on a button deck of the gaming machine, the button deck projecting forwardly from a gaming machine cabinet at a location below the object field.

16. The gaming machine of claim 10 wherein the selected result value is associated with the respective game object at the time the respective game object is first displayed in the object field.

17. The gaming machine of claim 10 wherein the selected result value is associated with the respective selected game object in response to the player selection input selecting that respective game object.

18. The gaming machine of claim 10 wherein the instructions are executable by the data processing system to:
(a) cause the video display system to display a bonus game object in the object field of the video display system;
(b) cause the video display system to display the bonus game object in a player selectable state for the bonus game object over a selection period for the bonus game object;
(c) receive a player selection input selecting the bonus game object residing in the object field while in the player selectable state for the bonus game object; and
(d) in response to the receipt of the player selection input selecting the bonus game object, cause the video display system to display the bonus game object transform to a bonus reveal state for the bonus game object and to display each of a number of the game objects then residing in the object field transform to a respective bonus reveal state for that respective game object displaying a respective bonus result value.

19. A program product comprising one or more non-transitory computer readable data storage devices storing program code, the program code including:
(a) game object graphic program code executable by a data processing system to cause a video display system of a gaming machine to display a number of game objects in an object field of the video display system where each game object is displayed in a player selectable state over a selection period for the respective game object and each game object is displayed as transforming to an unselected reveal state upon completion of the selection period for the respective game object, the unselected reveal state displaying an unselected result value;
(b) selection program code executable by the data processing system to receive a number of player selection inputs from a player input system of the gaming machine, each player selection input selecting a respective one of the game objects residing in the object field while in the player selectable state for that respective game object; and
(c) result display program code executable by the data processing system to, in response to the receipt of the player selection input for a respective game object while in the player selectable state for that respective game object, cause the video display system to display the respective selected game object transform to a selection area reveal state displaying a result value.
